(19) United States
(12) Patent Application Publication
(10) Pub. No.: US 2012/0082107 A1
(43) Pub. Date: Apr. 5, 2012

(54) METHOD AND APPARATUS FOR IMPLICIT SCELL DEACTIVATION IN A WIRELESS COMMUNICATION SYSTEM

(76) Inventors: Meng-Hui Ou, Taipei (TW); Richard Lee-Chee Kuo, Taipei (TW); Yu-Hsuan Guo, Taipei (TW)

(21) Appl. No.: 13/249,967

(22) Filed: Sep. 30, 2011

Related U.S. Application Data
(60) Provisional application No. 61/390,060, filed on Oct. 5, 2010.
(60) Provisional application No. 61/523,022, filed on Aug. 12, 2011.

(51) Int. Cl. H04W 72/04; H04W 74/00

(52) U.S. Cl. 370/329

(57) ABSTRACT

A method and apparatus for Secondary Cell (SCell) deactivation in a wireless communication system includes initiating a Random Access (RA) procedure associated with a SCell, and not implicit deactivating the SCell when the RA procedure associated with the SCell is initiated or the RA procedure associated with the SCell is ongoing.

### CROSS-REFERENCE TO RELATED APPLICATIONS

The present Application claims the benefit of U.S. Provisional Patent Application Ser. No. 61/390,060, filed on Oct. 5, 2010, and claims the benefit of U.S. Provisional Application Ser. No. 61/523,022, filed Aug. 12, 2011, the entire disclosures of which are incorporated herein by reference.

### FIELD

This disclosure generally relates to wireless communication networks, and more particularly, to a method and apparatus for implicit Secondary Cell (SCell) deactivation in a Wireless Communication System.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

According to one aspect, a method for Secondary Cell (SCell) deactivation in a wireless communication system includes initiating a Random Access (RA) procedure associated with a SCell, and not implicit deactivating the SCell when the RA procedure associated with the SCell is initiated or the RA procedure associated with the SCell is ongoing.

According to another aspect, a communication device for use in a wireless communication system includes a control circuit, a processor installed in the control circuit, and a memory installed in the control circuit and coupled to the processor. The processor is configured to execute a program code stored in memory to initiate a Random Access (RA) procedure associated with a SCell, and not implicit deactivate the SCell when the RA procedure associated with the SCell is initiated or the RA procedure associated with the SCell is ongoing.

According to another aspect, not implicit deactivating the SCell includes a User Equipment (UE) restarting or starting a deactivation timer for the SCell when the RA procedure is initiated on the SCell.

According to another aspect, not implicit deactivating the SCell includes a UE restarting a deactivation timer for the SCell when a Random Access Preamble is transmitted using a Physical Random Access Channel (PRACH) of the SCell or when instructing a physical layer to transmit a preamble using a PRACH of the SCell.

According to another aspect, not implicit deactivating the SCell includes a UE stopping or suspending a deactivation timer for the SCell when: (1) the RA procedure is initiated on the SCell; (2) the UE starts to perform backoff during the RA procedure; or (3) a contention resolution timer for the RA procedure is started.

According to another aspect, not implicit deactivating the SCell includes a UE not starting or not restarting a deactivation timer for the SCell if: (1) receiving a Physical Downlink Control Channel (PDCCH) addressed to a RA Radio Network Temporary Identifier (RA-RNTI) on the SCell; (2) receiving a PDCCH addressed to a Cell Radio Network Temporary Identifier (C-RNTI) on the SCell; or (3) the RA procedure is ongoing on the SCell.

According to another aspect, not implicit deactivating the SCell includes a UE performing one of: (1) setting a value of a deactivation timer for the SCell to infinity; or (2) disabling the implicit deactivation mechanism for the SCell.

According to another aspect, not implicit deactivating the SCell includes a UE not starting a deactivation timer for the SCell if a corresponding Time Alignment timer is not running upon activation of the SCell.

According to another aspect, not implicit deactivating the SCell includes a UE not deactivating the SCell associated with the RA procedure when a deactivation timer associated with the SCell expires while the RA procedure is ongoing

According to another aspect, not implicit deactivating the SCell comprises an eNodeB (eNB) not enabling implicit deactivation functionality for the SCell before the RA procedure is successfully completed

### BRIEF DESCRIPTION OF THE DRAWINGS

FIG. 1 shows a diagram of a wireless communication system according to one exemplary embodiment.

FIG. 2 shows a user plane protocol stack of the wireless communication system of FIG. 1 according to one exemplary embodiment.

FIG. 3 shows a control plane protocol stack of the wireless communication system of FIG. 1 according to one exemplary embodiment.

FIG. 4 is a block diagram of a transmitter system (also known as access network) and a receiver system (also known as UE) according to one exemplary embodiment.

FIG. 5 is a functional block diagram of a UE according to one exemplary embodiment.

FIG. 6 shows a method for implicit SCell deactivation according to one embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced). 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including R2-105220, “Introduction of Carrier Aggregation”. RP-100380. “Way forward on carrier aggregation deployment scenarios and multiple timing advance”, 3GPP TS 36.331 V9.3.0 (2010-06). “E-UTRA; RRC protocol specification”, 3GPP TS 36.321 V9.3.0 (2010-06). “E-UTRA; MAC protocol specification”. R2-104626, “UE's behaviour upon TAT expiry”, 3GPP IS 36.321 V10.2.0, “E-UTRA; MAC protocol specification”, R2-113578. “Updates of Carrier Aggregation agreements”, 3GPP TS 36.331 V10.2.0, “E-UTRA; RRC protocol specification”, and 3GPP TS 36.213 V10.2.0, “E-UTRA; Physical Layer Procedures”. The documents listed above are hereby in their entirety expressly incorporated by reference herein.

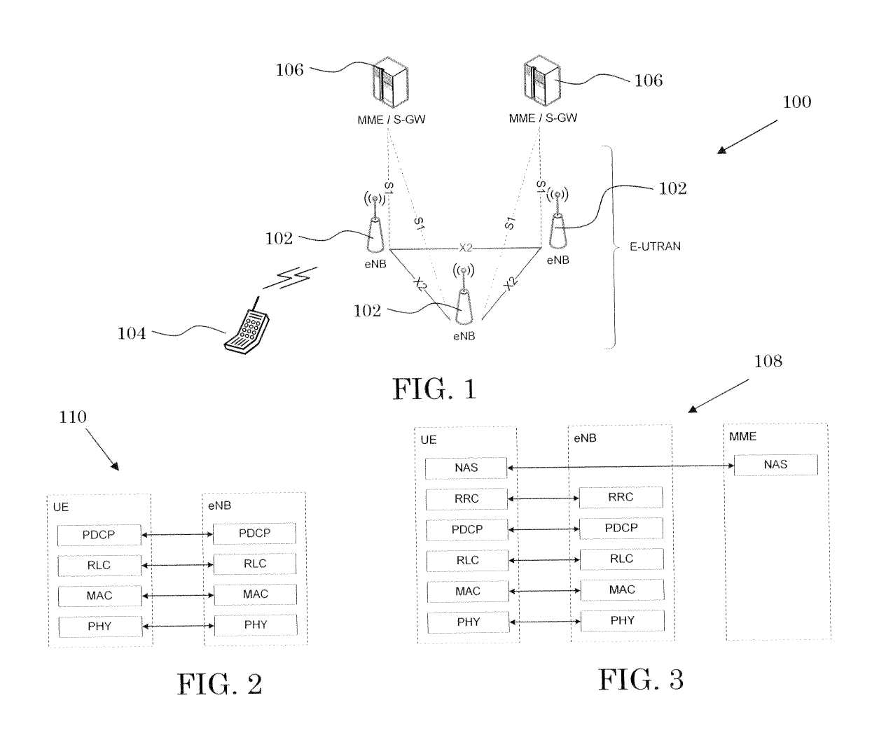

An exemplary network structure of an Evolved Universal Terrestrial Radio Access Network (E-UTRAN) 100 as a mobile communication system is shown in FIG. 1 according to one exemplary embodiment. The E-UTRAN system can also be referred to as a LTE (Long-Term Evolution) system or LTE-A (Long-Term Evolution Advanced). The E-UTRAN generally includes eNode B or eNB 102, which function similar to a base station in a mobile voice communication network. Each eNB is connected by X2 interfaces. The eNBs are connected to terminals or user equipment (UE) 104 through a radio interface, and are connected to Mobility Management Entities (MME) or Serving Gateway (S-GW) 106 through S1 interfaces.

Referring to FIGS. 2 and 3, the LTE system is divided into control plane 108 protocol stack (shown in FIG. 3) and user plane 110 protocol stack (shown in FIG. 2) according to one exemplary embodiment. The control plane performs a function of exchanging a control signal between a UE and an eNB and the user plane performs a function of transmitting user data between the UE and the eNB. Referring to FIGS. 2 and 3, both the control plane and the user plane include a Packet Data Convergence Protocol (PDCP) layer, a Radio Link Control (RLC) layer, a Medium Access Control (MAC) layer and a physical (PHY) layer. The control plane additionally includes a Radio Resource Control RRC) layer. The control plane also includes a Non-Access Stratum (NAS) layer, which performs among other things including Evolved Packet System (EPS) bearer management, authentication, and security control.

The PHY layer provides information transmission service using a radio transmission technology and corresponds to a first layer of an open system interconnection (OSI) layer. The PHY layer is connected to the MAC layer through a transport channel. Data exchange between the MAC layer and the PHY layer is performed through the transport channel. The transport channel is defined by a scheme through which specific data are processed in the PHY layer.

The MAC layer performs the function of sending data transmitted from a RLC layer through a logical channel to the PHY layer through a proper transport channel and further performs the function of sending data transmitted from the PHY layer through a transport channel to the RLC layer through a proper logical channel. Further, the MAC layer inserts additional information into data received through the logical channel, analyzes the inserted additional information from data received through the transport channel to perform a proper operation and controls a Random Access (RA) procedure.

The MAC layer and the RLC layer are connected to each other through a logical channel. The RLC layer controls the setting and release of a logical channel and may operate in one of an acknowledged mode (AM) operation mode, an unacknowledged mode (UM) operation mode and a transparent mode (TM) operation mode. Generally, the RLC layer divides Service Data Unit (SDU) sent from an upper layer at a proper size and vice versa. Further, the RLC layer takes charge of an error correction function through an automatic retransmission request (ARQ).

The PDCP layer is disposed above the RLC layer and performs a header compression function of data transmitted in an IP packet form and a function of transmitting data without loss even when an eNB providing a service changes due to the movement of a UE.

The RRC layer is only defined in the control plane. The RRC layer controls logical channels, transport channels and physical channels in relation to establishment, re-configuration and release of Radio Bearers (RBs). Here, the RB signifies a service provided by the second layer of an OSI layer for data transmissions between the terminal and the E-UTRAN. If an RRC connection is established between the RRC layer of a UE and the RRC layer of the radio network, the UE is in the RRC_CONNECTED mode. Otherwise, the UE is in an RRC_IDLE mode.

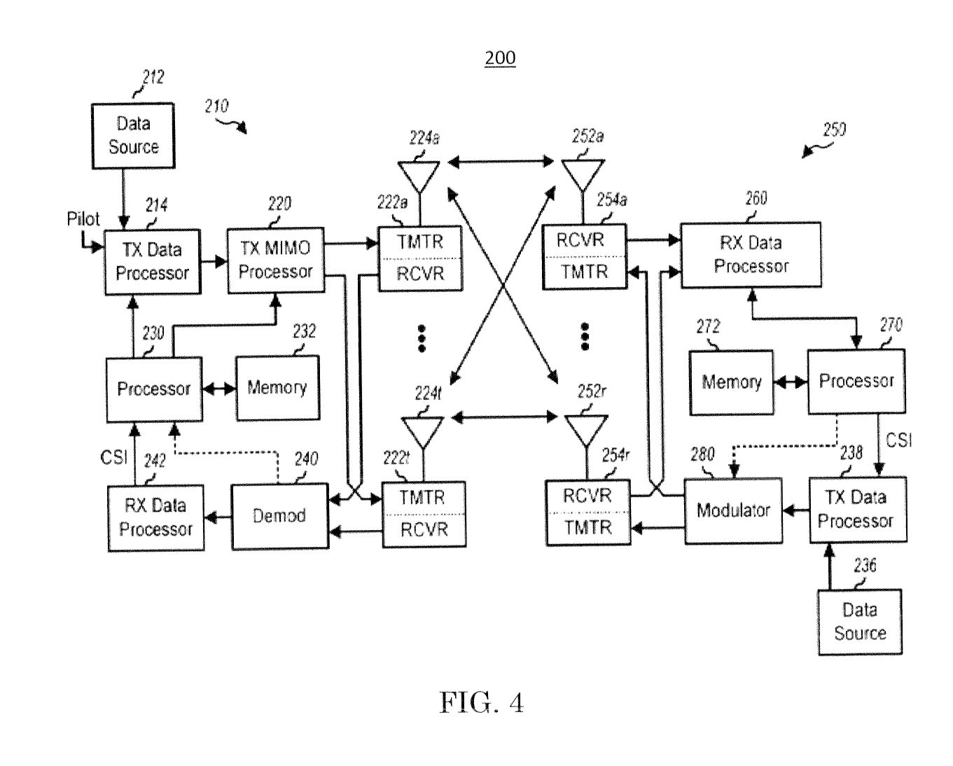

FIG. 4 is a simplified block diagram of an exemplary embodiment of a transmitter system 210 (also known as the access network) and a receiver system 250 (also known as access terminal or UE) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments. TX MIMO processor 220 applies beam forming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

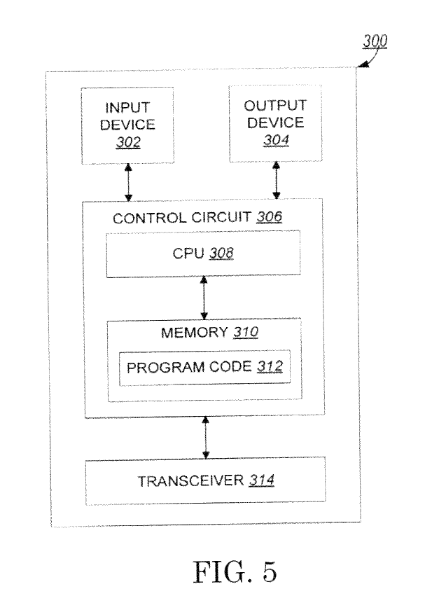

Turning to FIG. 5, this figure shows an alternative simplified functional block diagram of a communication device according to one exemplary embodiment. The communication device 300 in a wireless communication system can be utilized for realizing the UE 104 in FIG. 1, and the wireless communications system is preferably the LTE system, the LTE-A system or the like. The communication device 300 may include an input device 302, an output device 304, a control circuit 306, a central processing unit (CPU) 308, a memory 310, a program code 312, and a transceiver 314. The program code 312 includes the application layers and the layers of the control plane 108 and layers of user plane 110 as discussed above except the PHY layer. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

The LTE Downlink (DL) transmission scheme is based on Orthogonal Frequency Division Multiple Access (OFDMA), and the LTE Uplink (UL) transmission scheme is based on Single-Carrier (SC) Discrete Fourier Transform (DFT)-spread OFDMA (DFT-S-OFDMA) or equivalently. Single Carrier Frequency Division Multiple Access (SC-FDMA). LTE-Advanced (LTE-A), however, is designed to meet higher bandwidth requirements both in the DL and UL directions. In order to provide the higher bandwidth requirements. LTE-A utilizes carrier aggregation (CA) that aggregates multiple component carriers. A user equipment (UE) with reception and/or transmission capabilities for CA can simultaneously receive a/or transmit on multiple component carriers (CCs). A carrier may be defined by a bandwidth and a center frequency.

There are several physical control channels used in the physical layer that are relevant to CA operations. A physical downlink control channel (PDCCH) may inform the UE about the resource allocation of paging channel (PCH) and downlink shared channel (DL-SCH), about Hybrid Automatic Repeat Request (HARQ) information related to DL-SCH. The PDCCH may carry the uplink scheduling grant which informs the UE about resource allocation of uplink transmission. A physical downlink shared channel (PDSCH) carries data from DL-SCH. A physical control format indicator channel (PCFICH) informs the LTE about the number of OFDM symbols used for the PDCCHs and is transmitted in every subframe. A physical Hybrid ARQ Indicator Channel (PHICH) carries HARQ ACK/NAK signals in response to uplink transmissions. A physical uplink control channel (PUCCH) carries uplink control information such as HARQ ACK/NAK signals in response to downlink transmission, scheduling request (SR) and channel quality indicator (CQI). A physical uplink shared channel (PUTSCH) carries data from uplink shared channel (UL-SCH).

In LTE-A, a Primary Cell (PCell) is the serving ell operating in the primary frequency in which the UE either performs the initial connection establishment procedure or initiates the connection re-establishment procedure, or the cell indicated as the primary cell in the handover procedure. The LTE also uses the PCell to derive the parameters for the security functions and for upper layer system information such as NAS mobility information. A Secondary Cell or a Secondary serving Cell (SCell) includes the serving cell operating on a secondary frequency which may be configured once an RRC connection is established and which may be used to provide additional radio resources to achieve carrier aggregation. System information relevant for operation in the concerned SCell is typically provided using dedicated signaling when the SCell is added to the UE's configuration. Basically a PCell contains an uplink Component Carrier (CC) and a downlink CC, while a SCell configured to a UE may contain a downlink CC or an uplink CC along with a downlink CC.

To keep transmissions from different UEs orthogonal, uplink transmissions in LTE are aligned with the frame timing at the eNB. In LTE-A, PCell and SCell configured to a UE may need different Timing Advance values for uplink time alignment. When timing is not aligned yet or alignment was lost due to a period of inactivity during which time alignment was not maintained by the eNB, a Random Access (RA) procedure is performed to acquire time alignment. Accordingly, a RA procedure is used: for initial access from a disconnected state (RRC_IDLE) or radio link failure; for Handover requiring RA procedure; for DL or UL data arrival during RRC_CONNECTED after UL synchronization is lost possibly due to a power save operation; or UL data arrival when there are no dedicated scheduling request PUCCH channels available. There are two forms of the RA procedure, which are contention based and non-contention based. A contention based RA procedure can apply to all four of the events noted above, while a non-contention based RA procedure only applies to Handover and DL data arrival events noted above.

All the details of contention based and non-contention based RA procedures can be found in 3GPP TS 36.321 V9.3.0 and 3GPP TS 36.321 V10.2.0. RA procedure is briefly summarized in the following. In a contention based RA procedure, uplink time alignment is established with a four-phase procedure, which includes the four phases of RA Preamble, RA Response, Message 3 (Msg3) and Contention Resolution. In the RA Preamble phase, the UE randomly selects a RA preamble sequence from the set of sequences available in the cell and transmits it on a Random Access channel (RACH). In the RA Response phase, the eNB detects the preamble transmission, estimates the uplink transmission timing of the UE, and responds with an RA response providing the UE with the correct Timing Advance value to be used for subsequent transmissions and with a first grant for an uplink transmission. In the Msg3 phase, the UE uses the grant assigned by the RA response to provide its identity to the eNB with the first scheduled uplink transmission because the randomly selected RA preamble does not enable unique identification of the UE. In the Contention Resolution phase, the eNB receives the Msg3. Because only one Msg3 is typically received even if two or more were transmitted by contending UEs, the eNB resolves the contention by responding the UE who transmits the Msg3 received by eNB. Upon receiving the response, e.g. a PDCCH transmission or a transmission on DL-SCH containing UE identity, the UE concludes that the RA procedure is successful and uplink timing is aligned.

A wait period may be associated with a RA procedure. For example, a UE may have to wait for a RA Response, a Contention Resolution, or when in backoff time. Backoff time is described in the following. If the RA attempt of a UE fails, either because the preamble sent by the UE was not detected by the eNB or the UE lost the contention resolution, the UE has to start the RA Preamble phase again. To avoid contention and overload, the eNB can signal the UEs that they have to wait a certain time before they try again. The parameter that controls the wait period is called the backoff parameter and is signaled by the eNB in the RA response. The eNB can force the UE to wait a certain time before it tries to transmit RA Preamble again. The maximum length of the backoff time is signaled to the UE by the eNB with a backoff parameter, which is indicated by an index sent from the eNB to the UE. The backoff parameter is typically represented by an actual wait time in milliseconds and is called backoff time. Therefore, the backoff time is defined as the time a UE waits after an RA attempt has been declared unsuccessful until the UE is free to try again. The backoff time has a range of between 0 and 960 milliseconds according to 3GPP TS 36.321 V9.3.0 and 3GPP TS 36.321 V10.2.0.

In a non-contention based RA procedure, uplink time alignment is established with a two-phase procedure, which includes the two phases of RA Preamble and RA Response. In the RA Preamble phase, the UE uses a pre-assigned RA preamble sequence and transmits it on a Random Access channel (RACH). In the RA Response phase, the eNB detects the preamble transmission, estimates the uplink transmission timing of the UE, and responds with an PA response providing the UE with the correct timing-advance value to be used for subsequent transmissions and with a first grant for an uplink transmission. Upon receiving a RA response corresponding to the UE, the UE concludes that the RA procedure is successful and uplink timing is aligned.

When multiple Timing Advance (TA) is used, a SCell may need to perform a RA procedure to acquire its corresponding TA value and more than one serving cell may be able to perform RA procedure. For example, each of the serving cells uses RA procedure to acquire TA value for a TA group of configured serving cells which share the same TA. Accordingly, at least PDCCH order should be able to trigger a RA procedure on a SCell. In one possible scenario for triggering a RA procedure on a SCell, eNB configures a SCell which needs a TA value different from PCell's, eNB activates the SCell, eNB then transmits a PDCCH order to trigger a RA procedure on the SCell to let UL timing of SCell be aligned.

A SCell deactivation timer controls implicit deactivation of a configured SCell. The operation of the deactivation timer is described in R2-105220. “Introduction of Carrier Aggregation”, and 3GPP TS 36.321 V10.2.0, “E-UTRA; MAC protocol specification.” The deactivation timer for the SCell is started when the SCell is activated. The deactivation timer has a limited range, which may be 10 to 50 ms according to R2-104626, or 20 to 1280 ins as specified in 3GPP TS 36.331 V 10.2.0, “E-UTRA; RRC protocol specification.” Because a wait period may be associated with a RA procedure performed on a SCell (e.g., waiting for RA Response, Contention Resolution, or when in backoff time of 0-960 ms), it is possible that the UE implicitly deactivates the SCell when the deactivation time expires during a random access procedure performed on the SCell. However, this behaviour is unintended because the RA procedure is interrupted, the SCell needs to be activated again, and a RA procedure needs to be re-triggered. It causes unnecessary signaling and more delay for aligning UL timing of SCell. To prevent implicit deactivation of the SCell, eNB may need to keep transmitting downlink assignment or UL grant for the SCell to restart the deactivation timer, which can results in signalling overhead and resources waste.

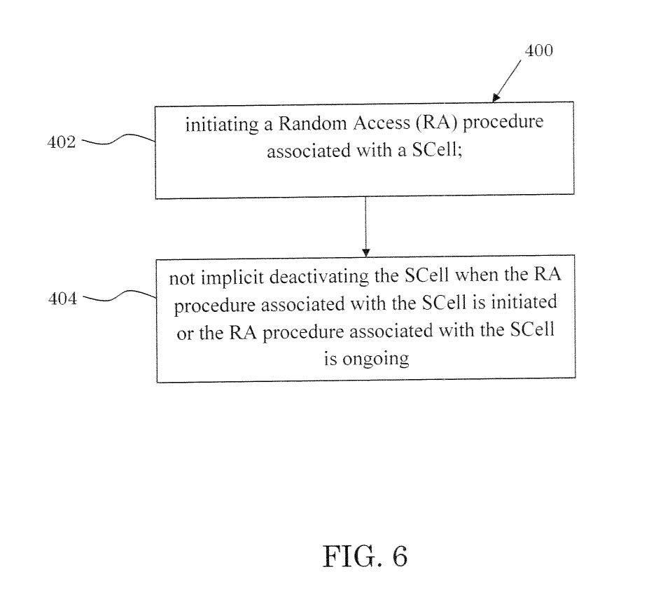

According to the embodiments described herein, when an RA procedure on a SCell is initiated or is ongoing, the SCell should not be implicitly deactivated. FIG. 6 shows a method 400 for SCell deactivation in a wireless communication system according to various embodiments. The method 400 includes initiating a RA procedure associated with a SCell at 402, and at 404, not implicitly deactivating the SCell when the RA procedure associated with the SCell is initiated or the RA procedure associated with the SCell is ongoing. Thus, implicit deactivation of a SCell which has an ongoing RA procedure can be prevented.

According to another embodiment, not implicit deactivating the SCell at 404 includes a UE restarting or starting the deactivation timer for the SCell when the RA procedure is initiated on the SCell. The timing to restart or start the deactivation timer for the SCell may be when receiving a PDCCH order for the SCell. The deactivation timer for a SCell may be restarted by the UE when a preamble is transmitted using the Physical RA Channel (PRACH) of the SCell or when instructing the physical layer to transmit a preamble using the PRACH of the SCell. All of the above-described actions may be partially or completely adopted and performed.

According to another embodiment, not implicit deactivating the SCell at 404 includes a UE stopping or suspending a deactivation timer for the SCell when the RA procedure is initiated on the SCell. The UE may not start or restart the deactivation timer for the SCell if: (1) the RA procedure on the SCell is ongoing; (2) receiving a PDCCH addressed to a Random Access Radio Network Temporary Identifier (RA-RNTI) on the SCell; or (3) receiving a PDCCH addressed to a Cell Radio Network Temporary Identifier (C-RNTI) on the SCell. When the RA procedure is successfully completed, the deactivation for the SCell may be restarted, started or resumed. When a UE starts to perform backoff during the RA procedure on the SCell, a deactivation timer for the SCell may be stopped or suspended. However, when the backoff is stopped, the UE restarts or resumes the deactivation timer for the SCell. When a contention resolution timer for the RA procedure on the SCell is started, a deactivation timer for the SCell may be stopped or suspended. Also, when the contention resolution timer is stopped or expires, the UE may restart or resume the deactivation timer for the SCell. All of the above-described actions may be partially or completely adopted and performed.

According to another embodiment, not implicit deactivating the SCell at 404 includes a UE setting a value of a deactivation timer for the SCell to infinity, or disabling the implicit deactivation mechanism for the SCell. When the RA procedure is successfully completed: (1) the value of the deactivation timer for the SCell may be set to the value configured by the eNB; (2) the implicit deactivation mechanism for the SCell may be resumed; or (3) the deactivation timer for the SCell may be started or restarted. All of the above-described actions may be partially or completely adopted and performed.

According to another embodiment, not implicit deactivating the SCell at 404 includes a UE not starting the deactivation timer for the SCell if the time alignment timer corresponding to the SCell is not running. The deactivation timer for the SCell may be started when the first RA procedure that is initiated on the SCell after the SCell is activated is successfully completed. All of the above-described actions may be partially or completely adopted and performed.

According to another embodiment, not implicit deactivating the SCell at 404 includes a UE not deactivating the SCell due to the expiry of a deactivation timer associated with the SCell if the RA procedure on the SCell or for the SCell is ongoing. The RA procedure may be on the SCell, which means that an RA preamble of the RA procedure is transmitted on the SCell. Alternatively, the RA procedure may be for the SCell, which means that an RA Preamble of the RA procedure is transmitted on another SCell, where the SCell and the another SCell belong to the same TA group. The deactivation timer for the SCell may be started or restarted when the deactivation timer expires. All HARQ buffers associated with the SCell may not be flushed due to the expiry of the deactivation timer. The deactivation timer may be sCellDeactivationTimer. The RA procedure may be contention based or non-contention based. If the RA procedure on or for the SCell is not ongoing, the deactivation timer may not be started or restarted when the deactivation timer expires. If the RA procedure on or for the SCell is not ongoing, the HARQ buffers associated with the SCell may be flushed when the deactivation timer expires. The HARQ buffers associated with the SCell may be flushed (in the Transmission Time Interval (TTI) according to the timing defined in 3GPP TS 36.213 V10.2.0. “E-UTRA; Physical Layer Procedures”, e.g. no later than subframe n+8 wherein the deactivation timer expires in subframe n) when the deactivation timer expires. If a RA procedure on or for the SCell is not ongoing, the SCell is deactivated (in the TTI according to the timing defined in 3GPP TS 36.213 V10.2.0. e.g. no later than subframe n+8 wherein the deactivation timer expires in subframe n) when the deactivation timer expires. The SCell may belong to a TA group which includes only one activated or only one serving sell (with UL), which is the SCell itself. All of the above-described actions may be partially or completely adopted and performed.

According to another embodiment, not implicit deactivating the SCell at 404 includes the eNB not enabling or never enabling implicit deactivation functionality for a first SCell, which may perform a RA procedure, before the RA procedure is successfully completed. The eNB may not enable or may never enable implicit deactivation functionality for the first SCell which may perform a RA procedure. However, the eNB may enable implicit deactivation functionality for the first SCell after the RA procedure is successfully completed. Furthermore, the eNB may enable implicit deactivation functionality for a second SCell which would not perform a RA procedure. Not enabling implicit deactivation functionality for the first SCell means that the value of sCellDeactivationTimer associated with the first SCell is not configured, e.g. the Information Element (IE) sCellDeactivationTimer is absent, or the value of sCellDeactivationTimer associated with the first SCell is set to infinity. SCell performing a RA procedure means a RA Preamble of the RA procedure is transmitted on the SCell. All of the above-described actions may be partially or completely adopted and performed.

For all of the above embodiments, a dedicated preamble may be used by the RA procedure. Furthermore, the RA procedure may be initiated by a PDCCH order for the SCell. Additionally, during the RA procedure, the eNB does not transmit a PDCCH addressed to C-RNTI for DL assignment or UL grant on the SCell. Also, the PDCCH order for the SCell may be received on the PCell. For all of the above embodiments, each process or procedure described with respect to one embodiment may be applicable to another one of the embodiments described above. All of the above-described actions may be partially or completely adopted and performed.

Referring to FIG. 5, which is a functional block diagram of a UE according to one exemplary embodiment, the UE 300 includes a program code 312 stored in memory 310. The CPU 308 executes the program code 312 to initiate an RA procedure associated with a SCell, and not implicit deactivate the SCell when the RA procedure associated with the SCell is initiated or the RA procedure associated with the SCell is ongoing. The CPU 308 can also execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices. e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory. ROM memory. EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for Secondary Cell (SCell) deactivation in a wireless communication system, the method comprising:
initiating a Random Access (RA) procedure associated with a SCell;
not implicit deactivating the SCell when the RA procedure associated with the SCell is initiated or the RA procedure associated with the SCell is ongoing.

2. The method of claim 1, wherein a dedicated preamble is used by the RA procedure.

3. The method of claim 1, wherein the RA procedure is initiated by a Physical Downlink Control Channel (PDCCH) order for the SCell.

4. The method of claim 3, wherein the PDCCH order for SCell is received on a Primary Cell (PCell).

5. The method of claim 1, wherein during the RA procedure, a eNodeB (eNB) does not transmit a Physical Downlink Control Channel (PDCCH) addressed to Cell Radio Network Identifier (C-RNTI) for downlink assignment or Uplink (UL) grant on the SCell.

6. The method of claim 1, wherein not implicit deactivating the SCell comprises a User Equipment (UE) restarting or starting a deactivation timer for the SCell when the RA procedure is initiated on the SCell.

7. The method of claim 6, wherein a timing to restart or start the deactivation timer for the SCell is when receiving the PDCCH order for the SCell.

8. The method of claim 1, wherein not implicit deactivating the SCell comprises a User Equipment (UE) restarting a deactivation timer for the SCell when a Random Access Preamble is transmitted using a Physical Random Access Channel (PRACH) of the SCell or when instructing a physical layer to transmit a preamble using a PRACH of the SCell.

9. The method of claim 1, wherein not implicit deactivating the SCell comprises:
a User Equipment (UE) stopping or suspending a deactivation timer for the SCell when:
the RA procedure is initiated on the SCell;
the User Equipment (UE) starts to perform backoff during the RA procedure; or
a contention resolution timer for the RA procedure is started.

10. The method of claim 1, wherein not implicit deactivating the SCell comprises:
a User Equipment (UE) not starting or not restarting a deactivation timer for the SCell if:
receiving a Physical Downlink Control Channel (PDCCH) addressed to a RA Radio Network Temporary Identifier (RA-RNTI) on the SCell;
receiving a PDCCH addressed to a Cell Radio Network Temporary Identifier (C-RNTI) on the SCell; or
the RA procedure is ongoing on the SCell.

11. The method of claim 9, wherein the deactivation time SCell is restarted, started or resumed when the RA procedure is successfully completed.

12. The method of claim 9, wherein the UE restarts or resumes the deactivation timer for the SCell when the backoff is stopped.

13. The method of claim 9, wherein the UE restarts or resumes the deactivation timer for the SCell when the contention resolution timer is stopped or expired.

14. The method of claim 1, wherein not implicit deactivating the SCell comprises a User Equipment (UE) performing one of:
setting a value of a deactivation timer for the SCell to infinity; or
disabling the implicit deactivation mechanism for the SCell.

15. The method of claim 14, further comprising performing one of
if the value of the deactivation timer for the SCell is set to infinity, setting the value of the deactivation timer for the SCell to a value configured by eNodeB (eNB) when the RA procedure is successfully completed;
if the implicit deactivation mechanism for the SCell is disabled, resuming the implicit deactivation mechanism for the SCell when the RA procedure is successfully completed; or
restarting or starting the deactivation timer for the SCell when the RA procedure is successfully completed.

16. The method of claim 1, wherein not implicit deactivating the SCell comprises a User Equipment (UE) not starting a deactivation timer for the SCell if a corresponding Time Alignment timer is not running upon activation of the SCell.

17. The method of claim 16, further comprising:
initiating a first RA procedure on the SCell after activating the SCell; and
starting the deactivation timer for the SCell when the first RA procedure is successful completed.

18. The method of claim 1, wherein not implicit deactivating the SCell comprises a User Equipment (UE) not deactivating the SCell associated with the RA procedure when a deactivation timer associated with the SCell expires while the RA procedure is ongoing.

19. The method of claim 18, wherein the RA procedure is on the SCell, and wherein the RA procedure on the SCell is defined by a RA preamble of the RA procedure being transmitted on the SCell.

20. The method of claim 18, wherein the RA procedure is for the SCell, and wherein the RA procedure for the SCell is defined by an RA Preamble of the RA procedure being transmitted on another SCell belonging to the same Timing Advance (TA) group as the SCell.

21. The method of claim 18, further comprising restarting or starting the deactivation when the deactivation timer expires.

22. The method of claim 18, wherein all Hybrid Automatic Repeat Request (HARQ) buffers associated with the SCell are not flushed upon expiry of the deactivation timer.

23. The method of claim 18, wherein the deactivation timer is sCellDeactivationTimer.

24. The method of claim 18, wherein the RA procedure is contention based or non-contention based.

25. The method of claim 18, further comprising not restarting or not starting the deactivation timer when the deactivation timer expires if the RA procedure is not ongoing.

26. The method of claim 18, further comprising flushing all Hybrid Automatic Repeat Request (HARQ) buffers associated with the SCell when the deactivation timer expires if the RA procedure is not ongoing.

27. The method of claim 18, further comprising deactivating the SCell when the deactivation timer expires if the RA procedure is not ongoing.

28. The method of claim 18, wherein the SCell belongs to a Timing Advance (TA) group and the TA group includes only one activated serving cell or only one serving cell.

29. The method of claim 1, wherein not implicit deactivating the SCell comprises an eNodeB (eNB) not enabling implicit deactivation functionality for the SCell before the RA procedure is successfully completed.

30. The method of claim 29, wherein initiating the RA procedure SCell comprises an RA Preamble of the RA procedure is transmitted on the SCell.

31. The method of claim 29, wherein the eNB enables implicit deactivation functionality for the SCell after the RA procedure is successfully completed.

32. The method of claim 29, wherein the eNB enables implicit deactivation functionality for another SCell not performing a RA procedure.

33. The method of claim 29, wherein not enabling implicit deactivation functionality for the SCell comprises not configuring the value of sCellDeactivationTimer associated with the SCell.

34. A communication device for use in a wireless communication system the communication device comprising:
a control circuit;
a processor installed in the control circuit; and
a memory installed in the control circuit and coupled to the processor;
Wherein the processor is configured to execute a program code stored in memory to:
initiate a Random Access (RA) procedure associated with a SCell;
not implicit deactivate the SCell when the RA procedure associated with the SCell is initiated or the RA procedure associated with the SCell is ongoing.

35. The communication device of claim 34, wherein not implicit deactivating the SCell comprises a User Equipment (UE) restarting or starting a deactivation timer for the SCell when the RA procedure is initiated on the SCell.

36. The communication device of claim 34, wherein not implicit deactivating the SCell comprises:
a User Equipment (UE) stopping or suspending a deactivation timer for the SCell when:
the RA procedure is initiated on the SCell;
the User Equipment (UE) starts to perform backoff during the RA procedure; or
a contention resolution timer for the RA procedure is started.

37. The communication device of claim 34, wherein not implicit deactivating the SCell comprises a User Equipment (UE) performing one of;
setting a value of a deactivation timer for the SCell to infinity; or
disabling the implicit deactivation mechanism for the SCell.

38. The communication device of claim 34, wherein not implicit deactivating the SCell comprises a User Equipment (UE) not starting a deactivation timer for the SCell if a corresponding Time Alignment timer is not running upon activation of the SCell.

39. The communication device of claim 34, wherein not implicit deactivating the SCell comprises a User Equipment (UE) not deactivating the SCell associated with the RA procedure when a deactivation timer associated with the SCell expires while the RA procedure is ongoing.

40. The communication device of claim 34, wherein not implicit deactivating the SCell comprises an eNodeB (eNB) not enabling implicit deactivation functionality for the SCell before the RA procedure is successfully completed.
